(19) United States
(12) Patent Application Publication
(10) Pub. No.: US 2022/0157093 A1
(43) Pub. Date: May 19, 2022

(54) DATA RECORDING DEVICE

(71) Applicant: TOYOTA JIDOSHA KABUSHIKI KAISHA, Toyota-shi (JP)

(72) Inventor: Katsuya SASAKI, Nagoya-shi (JP)

(73) Assignee: TOYOTA JIDOSHA KABUSHIKI KAISHA, Toyota-shi (JP)

(21) Appl. No.: 17/523,331

(22) Filed: Nov. 10, 2021

(30) Foreign Application Priority Data
Nov. 16, 2020 (JP) 2020-190403

(51) Int. Cl. G07C 5/08; G06F 16/2455; G06F 3/06

(52) U.S. Cl. CPC G07C 5/085; G06F 16/24564; G06F 3/0673; G06F 3/0604; G06F 3/0655

(57) ABSTRACT

A data recording device includes a mode storage unit configured to store a plurality of acquisition modes in which at least one of an acquisition timing of the data and an acquisition period of the data is determined. The data recording device includes a data extracting unit configured to extract some data out of the detected data. The data recording device includes a data storage unit configured to store the data extracted by the data extracting unit. The mode storage unit stores occurrence conditions of each of a plurality of events which occur in a vehicle and stores one acquisition mode in correlation with each of the plurality of events. The data extracting unit extracts the data in accordance with rules of the acquisition mode corresponding to the event of which the occurrence conditions are satisfied.

### CROSS-REFERENCE TO RELATED APPLICATION

This application claims priority to Japanese Patent Application No. 2020-190403 filed on Nov. 16, 2020, incorporated herein by reference in its entirety.

### BACKGROUND

### 1. Technical Field

The present disclosure relates to a data recording device.

### 2. Description of Related Art

Japanese Unexamined Patent Application Publication No. 2019-109697 (JP 2019-109697 A) discloses a data collecting device that collects data associated with an operation of a machine tool. The data collecting device acquires data in a predetermined cycle when an operation state of the machine tool satisfies specific conditions. The data collecting device records the acquired data in a database.

### SUMMARY

In the technique described in JP 2019-109697 A, a plurality of conditions serving as a trigger for acquisition of data may be set. In this case, when data is acquired in the cycle, the acquisition cycle of data may be too long and thus data at a necessary timing may not be acquired depending on types of the conditions serving as a trigger. On the other hand, when the cycle is short, much data may be unnecessarily acquired depending on the types of the conditions serving as a trigger. In this case, necessary data may not be recorded or a volume of data which is recorded may be more than necessary.

According to an aspect of the present disclosure, there is provided a data recording device that records data on a vehicle when an operation state of the vehicle satisfies occurrence conditions of an event, the data recording device including: a mode storage unit configured to store a plurality of acquisition modes in which at least one of an acquisition timing of the data and an acquisition period of the data is determined; a data extracting unit configured to extract some data out of the detected data; and a data storage unit configured to store the data extracted by the data extracting unit. Here, the mode storage unit is configured to store occurrence conditions of a plurality of events and to store one acquisition mode in correlation with each of the plurality of events, and the data extracting unit is configured to extract the data in accordance with rules of the acquisition mode corresponding to the event of which the occurrence conditions are satisfied.

With this configuration, data in an acquisition mode which is suitable for each event can be extracted by extracting the data in the acquisition mode dedicated for each event. Accordingly, it is possible to acquire necessary data at an appropriate timing for each event.

In the data recording device, an acquisition cycle of the data may be determined as the acquisition timing of the data for each acquisition mode. With this configuration, it is possible to acquire data at appropriate time intervals for each event.

In the data recording device, a period until acquisition of the data ends after the occurrence conditions have been satisfied may be determined as the acquisition period of the data for each acquisition mode. With this configuration, it is possible to acquire data in a period suitable for each event without setting a period in which data is acquired to be excessively long or excessively short.

In the data recording device, virtual data and a virtual acquisition timing at which the virtual data is considered to have been detected may be determined for each acquisition mode, and the data extracting unit may be configured to extract the virtual data which is determined for the acquisition mode corresponding to the event of which the occurrence conditions have been satisfied as the data detected at the virtual acquisition timing.

With this configuration, virtual data is extracted on the assumption that data is detected at an appropriate timing for each event. Accordingly, it is possible to prevent detection failure or extraction failure of data in which an acquired value or an acquisition timing thereof is determined in advance.

In the data recording device, when one of the plurality of events is a first event, the first event may be an event in which an internal combustion engine starts its ignition. When the acquisition mode correlated with the first event is a first acquisition mode, a torque of a starting motor that performs cranking of the internal combustion engine may be determined as a type of the acquired data for the first acquisition mode.

When the internal combustion engine is started, the torque of the starting motor can change suddenly due to cranking. With this configuration, it is possible to store change in torque of the starting motor associated with this sudden change in the data storage unit.

In the data recording device, when one of the plurality of events is a second event, the second event may be an event in which a brake device of the vehicle operates. When the acquisition mode correlated with the second event is a second acquisition mode, a torque of a traveling motor that is able to transmit power to driving wheels of the vehicle may be determined as a type of the acquired data for the second acquisition mode.

When a vehicle is braked while the vehicle is traveling, input of a torque from the traveling motor to the driving wheels may be hindered. Accordingly, the torque of the traveling motor may change suddenly. With this configuration, it is possible to store change in torque of the traveling motor associated with this sudden change in the data storage unit.

In the data recording device, when one of the plurality of events is a third event, the third event may be an event in which a state in which a change per unit time of an acceleration in a vertical direction of the vehicle is equal to or greater than a prescribed value is maintained for a prescribed period or longer. When the acquisition mode correlated with the third event is a third acquisition mode, a torque of a traveling motor that is able to transmit power to driving wheels of the vehicle may be determined as a type of the acquired data for the third acquisition mode.

When a vehicle travels on an undulating road having a road surface with consecutive undulations, the acceleration in the vertical direction of the vehicle pulsates with a large amplitude. That is, the third event corresponds to a situation in which the vehicle is traveling on an undulating road. When the vehicle is traveling on an undulating road, change in rotation of the driving wheels due to undulations of the road surface is applied to the traveling motor. Accordingly, the torque of the traveling motor may change suddenly. With this configuration, it is possible to store change in torque of the traveling motor associated with this sudden change in the data storage unit.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically illustrating a configuration of a vehicle;

FIG. 2 is a diagram illustrating an event map according to a first embodiment;

FIG. 3 is a diagram illustrating an example of an acquisition mode of data according to the first embodiment;

FIG. 4 is a diagram illustrating an event map according to a second embodiment;

FIG. 5 is a diagram illustrating an example of an acquisition mode of data according to the second embodiment;

FIG. 6 is a diagram schematically illustrating a modified example of a data recording device; and

FIG. 7 is a diagram schematically illustrating another modified example of the data recording device.

### DETAILED DESCRIPTION OF EMBODIMENTS

### First Embodiment

Hereinafter, a data recording device according to a first embodiment will be described with reference to the accompanying drawings.

### Schematic Configuration of Vehicle

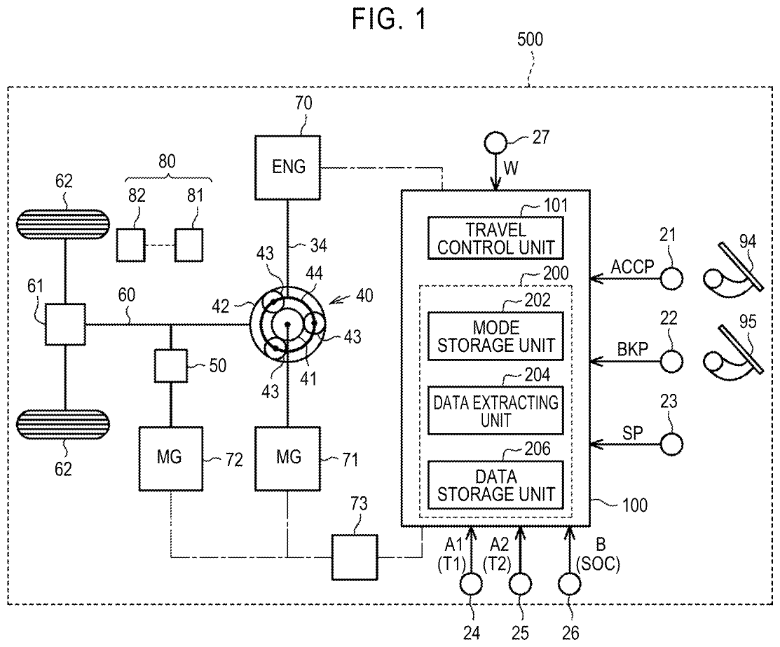

As illustrated in FIG. 1, a hybrid vehicle (hereinafter referred to as a vehicle) 500 includes an internal combustion engine 70, a first motor generator (hereinafter referred to as a first MG) 71, a second motor generator (hereinafter referred to as a second MG) 72, a planetary gear mechanism 40, a reduction gear 50, a differential 61, driving wheels 62, and a battery 73.

The internal combustion engine 70, the first MG 71, and the second MG 72 serve as drive sources of the vehicle 500. The first MG 71 is a generator motor having functions of both an electric motor and a power generator. Similarly to the first MG 71, the second MG 72 is a generator motor. The first MG 71 and the second MG 72 are electrically connected to a battery 73 via an inverter. The battery 73 supplies electric power to the first MG 71 and the second MG 72 or stores electric power which is supplied from the first MG 71 and the second MG 72. The inverter converts electric power between a direct current and an alternating current. The inverter is not illustrated in FIG. 1.

The internal combustion engine 70 and the first MG 71 are connected to the planetary gear mechanism 40. The planetary gear mechanism 40 includes a sun gear 41, a ring gear 42, a plurality of pinion gears 43, and a carrier 44. The sun gear 41 is an externally toothed gear. The ring gear 42 is an internally toothed gear. The ring gear 42 is configured to be rotatable coaxially with the sun gear 41. The plurality of pinion gears 43 is interposed between the sun gear 41 and the ring gear 42. The plurality of pinion gears 43 engages with both the sun gear 41 and the ring gear 42. The carrier 44 supports the plurality of pinion gears 43. The carrier 44 is configured to be rotatable coaxially with the sun gear 41.

The sun gear 41 is connected to a rotation shaft of the first MG 71. The carrier 44 is connected to a crank shaft 34 which is an output shaft of the internal combustion engine 70. The ring gear 42 is connected to a drive shaft 60. The drive shaft 60 is connected to the second MG 72 via a reduction gear 50. The reduction gear 50 reduces a torque of the second MG 72 and transmits the reduced torque to the drive shaft 60. The drive shaft 60 is connected to the right and left driving wheels 62 via a differential 61. The differential 61 permits a difference in rotation speed between the right and left driving wheels 62.

The internal combustion engine 70 and the first MG 71 can transmit power to each other via the planetary gear mechanism 40. When a torque of the internal combustion engine 70 is input to the first MG 71, the first MG 71 functions as a power generator. On the other hand, when the first MG 71 functions as an electric motor, cranking for rotating the crank shaft 34 can be performed using the torque of the first MG 71. That is, the first MG 71 is a starting motor that performs cranking of the internal combustion engine 70.

When the vehicle 500 decreases its speed, a regenerative braking force based on an amount of electric power generated by the second MG 72 is generated in the vehicle 500 by causing the second MG 72 to function as a power generator. On the other hand, when the second MG 72 is caused to function as an electric motor, the torque of the second MG 72 can be input to the driving wheels 62 via the reduction gear 50, the drive shaft 60, and the differential 61. That is, the second MG 72 is a traveling motor.

The vehicle 500 includes a brake device 80. The brake device 80 includes a hydraulic circuit 81 and a brake mechanism 82. The hydraulic circuit 81 generates a hydraulic pressure. The brake mechanism 82 is connected to the hydraulic circuit 81. The brake mechanism 82 operates with a hydraulic pressure of the hydraulic circuit 81. When the hydraulic pressure of the hydraulic circuit 81 increases, brake pads of the brake mechanism 82 are pressed against the driving wheels 62. Accordingly, the brake mechanism 82 brakes the driving wheels 62.

The vehicle 500 includes an accelerator pedal 94 and a brake pedal 95. The accelerator pedal 94 and the brake pedal 95 are foot pedals which are depressed by an occupant. A hydraulic pressure is generated in the hydraulic circuit 81 of the brake device 80 based on a brake operation amount BKP which is an amount of operation of the brake pedal 95.

The vehicle 500 includes an accelerator sensor 21, a brake sensor 22, a vehicle speed sensor 23, a first current sensor 24, a second current sensor 25, a battery sensor 26, and an acceleration sensor 27. The accelerator sensor 21 detects an accelerator operation amount ACCP which is an amount of operation of the accelerator pedal 94. The brake sensor 22 detects the brake operation amount BKP. The vehicle speed sensor 23 detects a vehicle speed SP which is a travel speed of the vehicle 500. The first current sensor 24 detects a current A1 flowing in the first MG 71. The first current sensor 24 detects the current A1 with a positive value when the first MG 71 functions as an electric motor, and detects the current A1 with a negative value when the first MG 71 functions as a power generator. The second current sensor 25 detects a current A2 flowing in the second MG 72. The second current sensor 25 detects the current A2 with a positive value when the second MG 72 functions as an electric motor, and detects the current A2 with a negative value when the second MG 72 functions as a power generator. The battery sensor 26 detects battery information B including a current, a voltage, and a temperature of the battery 73. The acceleration sensor 27 detects a vertical acceleration W which is an acceleration in a vertical direction of the vehicle 500.

Schematic Configuration of Control Device

The vehicle 500 includes a control device 100. The control device 100 can be constituted by one or more processors that perform various processes in accordance with a computer program (software). The control device 100 may be constituted by circuitry including one or more dedicated hardware circuits such as an application-specific integrated circuit (ASIC) or a combination thereof which performs at least some of various processes. Each processor includes a CPU and a memory such as a random access memory (RAM) and a read only memory (ROM). The memory stores program codes or commands configured to cause the CPU to perform processes. Examples of the memory, that is, a computer-readable medium, include all available media which can be accessed by a general-purpose or dedicated computer. The control device 100 includes a storage device which is an electrically writable nonvolatile memory.

The control device 100 receives detection signals from various sensors that are attached to the vehicle 500. Specifically, the control device 100 receives detection signals for the following parameters.
An accelerator operation amount ACCP that is detected by the accelerator sensor 21
A brake operation amount BKP that is detected by the brake sensor 22
A vehicle speed SP that is detected by the vehicle speed sensor 23
A current A1 flowing in the first MG 71, which is detected by the first current sensor 24
A current A2 flowing in the second MG 72, which is detected by the second current sensor 25.
Battery information B that is detected by the battery sensor 26
A vertical acceleration W that is detected by the acceleration sensor 27

The control device 100 handles the current A1 flowing in the first MG 71 as a value which is converted to a torque in performing various processes. That is, the control device 100 handles the current A1 flowing in the first MG 71 as a torque of the first MG 71 (hereinafter referred to as a first MG torque) T1. Similarly, the control device 100 handles the current A2 flowing in the second MG 72 as a torque of the second MG 72 (hereinafter referred to as a second MG torque) T2. The control device 100 handles a powering torque as a positive value and handles a regenerative torque as a negative value. The control device 100 calculates a state of charge SOC of the battery 73 based on the battery information B.

The control device 100 includes a travel control unit 101. The travel control unit 101 controls travel of the vehicle 500 through control of the internal combustion engine 70, the first MG 71, and the second MG 72. Specifically, the travel control unit 101 calculates a required vehicle output which is a required value for an output necessary for the vehicle 500 to travel based on the accelerator operation amount ACCP and the vehicle speed SP. The travel control unit 101 determines a distribution of torque to the internal combustion engine 70, the first MG 71, and the second MG 72 based on the required vehicle output and the state of charge SOC of the battery 73. The travel control unit 101 calculates a target torque of each of the internal combustion engine 70, the first MG 71, and the second MG 72 based on the determined distribution of torque. Then, the travel control unit 101 controls the internal combustion engine 70, the first MG 71, and the second MG 72 such that the calculated target torques are realized.

The travel control unit 101 causes the vehicle 500 to travel in a state in which the internal combustion engine 70 is operating or causes the vehicle 500 to travel in a state in which the internal combustion engine 70 is stopped according to circumstances. For example, when the state of charge SOC of the battery 73 is low or when a required driving force is large, the travel control unit 101 causes the vehicle 500 to travel in a state in which the internal combustion engine 70 is operating. The travel control unit 101 starts or stops the internal combustion engine 70 depending on whether the vehicle 500 is traveling in a state in which the internal combustion engine 70 is operating. When the internal combustion engine 70 is started, the travel control unit 101 performs cranking of the internal combustion engine 70 by applying the torque of the first MG 71 to the internal combustion engine 70.

### <Configuration of Data Recording Device>

The control device 100 functions as a data recording device 200 that stores a plurality of pieces of diagnosis data in a time series. The pieces of diagnosis data are determined as data necessary to ascertain the state of the vehicle 500 out of a plurality of pieces of data received from various sensors by the control device 100 in advance. The first MG torque T1 and the second MG torque T2 are included in the plurality of pieces of diagnosis data. The control device 100 includes a data storage unit 206, a data extracting unit 204, and a mode storage unit 202 as functional units for recording the pieces of diagnosis data. The control device 100 normally monitors the time series of the pieces of diagnosis data in order to ascertain the state of the vehicle 500.

The data storage unit 206 stores diagnosis data which is written thereto. In the data storage unit 206, a writable data capacity assigned to each piece of diagnosis data is determined in advance. When each piece of diagnosis data is written thereto, the data storage unit 206 stores the diagnosis data in a time series within the data capacity while rewriting oldest data with newest data for each piece of diagnosis data. The data storage unit 206 is constituted by the storage device of the control device 100.

The data extracting unit 204 performs acquisition of diagnosis data and writing of the acquired diagnosis data to the data storage unit 206. In acquiring the diagnosis data, the data extracting unit 204 acquires the diagnosis data by thinning out the diagnosis data received by the control device 100 in a time direction. That is, data extracting unit 204 extracts some of data detected by the sensors. The data extracting unit 204 is constituted by the CPU and the ROM of the control device 100.

The data extracting unit 204 basically acquires the diagnosis data in a normal acquisition cycle PN. For example, in association with an event which occurs in the vehicle 500 such as ignition of the internal combustion engine 70, the magnitude of a physical quantity associated with the event may vary at time scales shorter than the normal acquisition cycle PN. As a process of recording such variation in a physical quantity at short time scales on the data storage unit 206, the data extracting unit 204 can perform an event process. Specifically, the event process is a process of acquiring specific diagnosis data out of a plurality of pieces of diagnosis data in a cycle shorter than the normal acquisition cycle PN and recording the acquired diagnosis data on the data storage unit 206 when an operation state of the vehicle 500 satisfies occurrence conditions of the event. The data extracting unit 204 extracts the diagnosis data based on rules of an acquisition mode corresponding to the event of which the occurrence conditions are satisfied in the event process. The acquisition mode will be described later.

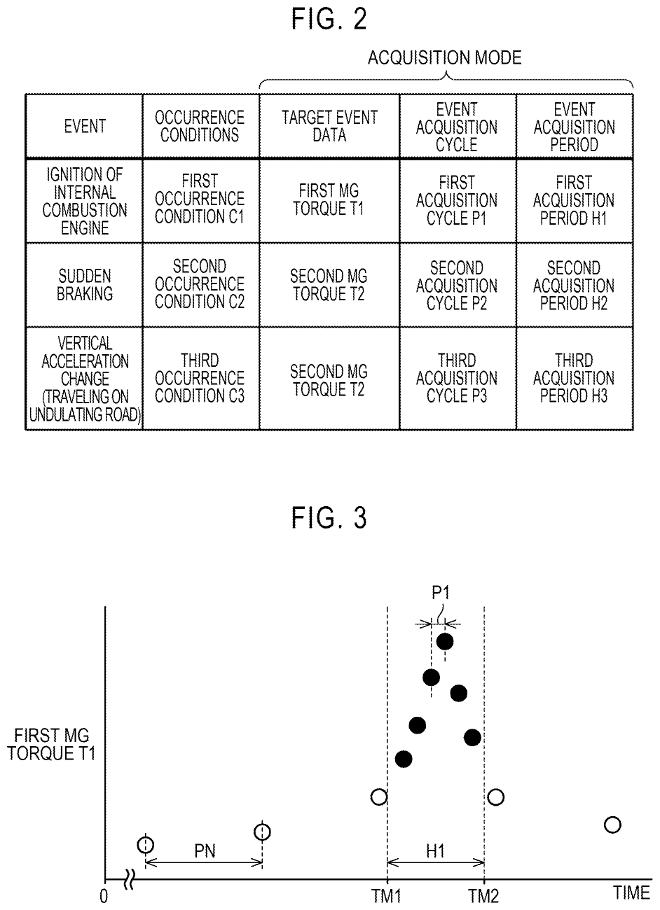

The mode storage unit 202 stores an event map. As illustrated in FIG. 2, in the event map, three events, occurrence conditions for the three events, and one acquisition mode for each of the three events are determined in correlation with each other. In each acquisition mode, a type of the acquired data, an acquisition timing of the data, and an acquisition period of the data are determined. Specifically, target event data which is the type of the acquired data is determined in each acquisition mode. In each acquisition mode, an event acquisition cycle which is an acquisition cycle of the target event data is determined as the acquisition period of data. In each acquisition mode, an event acquisition period which is a period until acquisition of the target event data in the event acquisition period ends after occurrence conditions of the event have been satisfied is determined as the acquisition period of data. The mode storage unit 202 is constituted by the ROM of the control device 100.

### Specific Details of Event Map

Details of three events will be sequentially described below.

A first event will be first described. The first event which is one of the three events determined in the event map is to start the internal combustion engine 70. A first occurrence condition C1 which is occurrence conditions of the first event is the same as conditions when the travel control unit 101 starts the internal combustion engine 70. That is, an example of the first occurrence condition C1 is that the state of charge SOC of the battery 73 decreases to a value in which charging of the battery 73 is necessary. Another example of the first occurrence condition C1 is that a required driving force increases to a value in which the required driving force cannot be covered by only the second MG 72.

Target event data of the first event is the first MG torque T1. When the internal combustion engine 70 is started, the internal combustion engine 70 is cranked by applying the first MG torque T1 to the internal combustion engine 70. The first MG torque T1 at this time is a powering torque and has a positive value. The first MG torque T1 temporarily increases suddenly by cranking the internal combustion engine 70. Thereafter, when the cranking of the internal combustion engine 70 ends, the first MG torque T1 decreases suddenly. A first acquisition cycle P1 which is the event acquisition cycle of the first event is set to a maximum value of a time interval which is required to appropriately ascertain a series of transitions from the sudden increase of the first MG torque T1 due to starting of the internal combustion engine 70 to the sudden decrease thereof. The first acquisition cycle P1 is determined, for example, by experiment. A first acquisition period H1 which is the event acquisition period of the first event is set to a minimum value of a period in which the series of transitions of the first MG torque T1 due to starting of the internal combustion engine 70 can be ascertained to the end. The first acquisition period H1 is determined, for example, by experiment.

A second event will be described below. The second event which is one of the three events determined in the event map is that the brake device 80 performs a sudden braking operation. A second occurrence condition C2 which is occurrence conditions of the second event is, for example, that the brake pedal 95 is operated by a prescribed amount of operation or more in a state in which an operation speed of the brake pedal 95 is equal to or higher than a prescribed speed. The prescribed speed and the prescribed amount of operation are determined as values in which the brake device 80 can be considered to perform a sudden braking operation, for example, by experiment. The operation speed of the brake pedal 95 is a change of a brake operation amount BKP per unit time.

Target event data of the second event is the second MG torque T2. As described above, the second MG 72 and the driving wheels 62 are connected to each other in a power-transmittable manner. While the vehicle 500 is traveling, a torque is input from the second MG 72 to the driving wheels 62. The torque at this time is a powering torque and has a positive value. When the brake device 80 suddenly brakes the driving wheels 62 while the torque is inputting from the second MG 72 to the driving wheels 62, the torque which is to be inherently input from the second MG 72 to the driving wheels 62 is not input to the driving wheels 62 but stays in the second MG 72. Accordingly, the torque in the second MG 72 increases instantaneously. When the brake device 80 performs a sudden braking operation, the accelerator operation amount ACCP is generally zero. Accordingly, the required driving force is zero. For this reason, the second MG torque T2 temporarily increases suddenly and then decreases suddenly in the aforementioned process. A second acquisition cycle P2 which is an event acquisition cycle of the second event is set to a maximum value of a time interval required to appropriately ascertain a series of transitions from the sudden increase to the sudden decrease of the second MG torque T2 due to the sudden braking operation of the brake device 80. The second acquisition cycle P2 is determined, for example, by experiment. A second acquisition period H2 which is an event acquisition period of the second event is set to a minimum value of a period in which the series of transitions of the second MG torque T2 due to the sudden braking operation of the brake device 80 can be ascertained to the end. The second acquisition period H2 is determined, for example, by experiment.

A third event will be described below. The third event which is one of the three events determined in the event map is that a state in which a change per unit time of a vertical acceleration W (hereinafter referred to as a rate of change of the vertical acceleration W) is equal to or greater than a prescribed value is maintained during a prescribed period or more. When the vehicle 500 travels on an undulating road having a road surface with successive undulations, the vertical acceleration W pulsates with great amplitude. That is, the third event corresponds to a situation in which the vehicle 500 is traveling on an undulating road. The prescribed value is, for example, a value which is agreeably greater than a maximum value of the rate of change of the vertical acceleration W which may be generated when the vehicle 500 is traveling on a level road in a normal traveling state. A distance which can be considered to be a smallest successive distance out of a successive distance of an undulating road is referred to as a minimum successive distance. The prescribed period is, for example, a period of time required for the vehicle 500 to travel the minimum successive distance at a vehicle speed SP which can be considered to be normal. The vehicle speed SP which can be considered to be normal is, for example, an average vehicle speed SP when the vehicle 500 travels on a general road and is, for example, 50 km/h.

A third occurrence condition C3 which is occurrence conditions of the third event is, for example, that a state in which the rate of change of the vertical acceleration W is equal to or greater than a prescribed value is maintained in a determination period or longer. The rate of change of the vertical acceleration W may increase during a very short period due to local undulations on the road surface. The determination period is determined as a time which is agreeably longer than a period in which the state in which the rate of change of the vertical acceleration W is equal to or greater than the prescribed value is maintained due to the local undulations, for example, by experiment. That is, the determination period is set to a period in which the state in which the rate of change of the vertical acceleration W is great can be predicted to be maintained even after the rate of change of the vertical acceleration W has been equal to or greater than the prescribed value.

Target event data of the third event is the second MG torque T2. When the vehicle 500 travels on an undulating road, the driving wheels 62 switch repeatedly between a gripped state and a slipping state. When the driving wheels 62 are in the gripped state, the driving wheels 62 are braked. Accordingly, similarly to the case of the second event, the second MG torque T2 increases instantaneously. On the other hand, when the driving wheels 62 are in the slipping state, the torque stored in the second MG 72 is released. Accordingly, the second MG torque T2 decreases. Accordingly, when the driving wheels 62 switch repeatedly between the gripped state and the slipping state while the vehicle 500 is traveling on an undulating road, the second MG torque T2 switches repeatedly between sudden increase and sudden decrease. A third acquisition cycle P3 which is an event acquisition cycle of the third event is set to a maximum value of a time interval required to appropriately ascertain a series of transitions of vertical movement of the second MG torque T2 due to the vehicle 500 traveling on an undulating road. The third acquisition cycle P3 is determined, for example, by experiment. A distance which can be considered to be a successive distance of an undulating road is referred to as an undulating road distance. A third acquisition period H3 which is an event acquisition period of the third event is a period of time required for the vehicle 500 to travel over the undulating road distance at a vehicle speed SP which can be considered to be normal. That is, the third acquisition period H3 is set to a minimum value of a period in which the series of transitions of the second MG torque T2 due to the vehicle 500 traveling on the undulating road can be ascertained to the end. The third acquisition period H3 is determined, for example, by experiment. The undulating road distance is, for example, an average value of successive distances of various undulating roads.

The event acquisition cycles of the three events are shorter than the normal acquisition cycle PN. The event acquisition cycles of the three events are different from each other. The event acquisition periods of the three events are different from each other.

Specific Process Details Performed by Data Extracting Unit

The data extracting unit 204 normally acquires diagnosis data in the non Jai acquisition cycle PN while an ignition switch of the vehicle 500 is in an ON state. Whenever diagnosis data is acquired, the data extracting unit 204 writes the acquired diagnosis data to the data storage unit 206. The ignition switch is a starting switch of the control device 100. The ignition switch may be referred to as a power switch.

When the ignition switch of the vehicle 500 is in the ON state, the data extracting unit 204 normally monitors whether occurrence conditions of a plurality of events are satisfied while acquiring the diagnosis data in the normal acquisition cycle PN. Specifically, the data extracting unit 204 normally refers to the event map stored in the mode storage unit 202. Accordingly, the data extracting unit 204 normally refers to parameters indicating the state of the vehicle 500, which are required to determine whether occurrence conditions of each event are satisfied. The data extracting unit 204 repeatedly determines whether the occurrence conditions of each of the plurality of events are satisfied.

When occurrence conditions of one of the plurality of events determined in the event map are satisfied, the data extracting unit 204 reads an acquisition mode for the event of which the occurrence conditions have been satisfied from the event map. That is, the data extracting unit 204 reads target event data, an event acquisition cycle, and an event acquisition period of the event of which the occurrence conditions have been satisfied from the event map. Then, the data extracting unit 204 performs an event process on the event of which the occurrence conditions have been satisfied. Specifically, the data extracting unit 204 acquires target event data in the event acquisition period with the event acquisition cycle. When the target event data is acquired, the data extracting unit 204 writes the acquired data to the data storage unit 206. When the event acquisition period has elapsed after the occurrence conditions of the event have been satisfied, the data extracting unit 204 ends the event process. While the event process is being performed, the data extracting unit 204 cancels determination of whether occurrence conditions of the event which is subjected to the event process have been satisfied. When the event process ends, the data extracting unit 204 restarts the cancelled determination.

When occurrence conditions of a plurality of events are simultaneously satisfied or when occurrence conditions of one event are satisfied while an event process for another event is being performed, the data extracting unit 204 performs event processes for a plurality of events in parallel. When the event process for the second event and the event process for the third event overlap, data in the same time series is written. When writing timings thereof completely overlap each other, writing of one piece of data may be cancelled or writing of two pieces of data may be overlapped.

### Operation of First Embodiment

A data acquisition flow will be described below using the first event as an example.

It is assumed herein that the data extracting unit 204 performs acquisition of a first MG torque T1 and writing of the acquired first MG torque T1 to the data storage unit 206 in the normal acquisition cycle PN. As illustrated in FIG. 3, it is assumed that the first occurrence condition C1 is satisfied at a time TM1 while the data extracting unit 204 is repeatedly acquiring the first MG torque T1 in the normal acquisition cycle PN. As described above when the internal combustion engine 70 is started, the first MG torque T1 increases suddenly due to cranking of the internal combustion engine 70 and then decreases suddenly. This series of change of the first MG torque T1 occurs in a period which is shorter than the normal acquisition cycle PN. Accordingly, when the first MG torque T1 is acquired in the normal acquisition cycle PN, accurate transitions of the first MG torque T1 due to cranking of the internal combustion engine 70 cannot be recorded on the data storage unit 206.

Therefore, the data extracting unit 204 starts an event process for the first event at the time TM1. That is, the data extracting unit 204 acquires the first MG torque T1 in the first acquisition cycle P1 shorter than the normal acquisition cycle PN and writes the acquired first MG torque T1 to the data storage unit 206 after the time TM1. In FIG. 3, the first MG torque T1 acquired in the normal acquisition cycle PN is represented by white circles and the first MG torque T1 acquired in the first acquisition cycle P1 is represented by black circles.

The data extracting unit 204 acquires the first MG torque T1 in the first acquisition cycle P1 from the time TM1 to a time TM2 at which the first acquisition period H1 has elapsed. At the time TM2, the data extracting unit 204 ends the event process. The data extracting unit 204 continues to acquire the first MG torque T1 in the normal acquisition cycle PN after the time TM2.

Similarly to the first event, regarding sudden braking of the brake device 80 which is the second event, a series of processes from sudden increase of the second MG torque T2 to sudden decrease thereof due to the sudden braking occurs in a period shorter than the normal acquisition cycle PN. Therefore, when the second occurrence condition C2 has been satisfied, the data extracting unit 204 acquires the second MG torque T2 in the second acquisition cycle P2 shorter than the normal acquisition cycle PN. In the third event, the cycle of vertical movement of the second MG torque T2 due to the vehicle 500 traveling on an undulating road is shorter than the normal acquisition cycle PN. Therefore, when the third occurrence condition C3 has been satisfied, the data extracting unit 204 acquires the second MG torque T2 in the third acquisition cycle P3 shorter than the normal acquisition cycle PN.

### Advantages of First Embodiment

(1-1) In this embodiment, the event acquisition cycle and the event acquisition period dedicated for each event are determined. Accordingly, it is possible to record transitions of target event data of an event which cannot be ascertained in the normal acquisition cycle PN at appropriate time intervals in an appropriate period for each event.

(1-2) In order to decrease a burden of processing of the control device 100, it is preferable to increase the event acquisition cycle for each event as much as possible. On the other hand, when the event acquisition cycle for each event is increased, transitions of target event data thereof may be erroneously ascertained.

In this embodiment, the event acquisition cycle for each event is set to a maximum value of a time interval which is required to appropriately ascertain transitions of the target event data for each event. Accordingly, it is possible to minimize a burden of processing of the control device 100 and to record a time series in which transitions of the target event data for each event are appropriately reflected.

(1-3) In order to decrease a burden of processing of the control device 100, it is preferable to decrease the event acquisition period for each event as much as possible. On the other hand, when the event acquisition period for each event is decreased, acquisition of data in the event acquisition cycle may be completed before a timing at which change of the target event data due to the corresponding event ends.

In this embodiment, the event acquisition period for each event is set to a minimum value of a period which is required to ascertain transitions of the target event data for each event to the end. Accordingly, it is possible to minimize a burden of processing of the control device 100 and to record a time series in which transitions of the target event data for each event are reflected to the end.

(1-4) When the first MG torque T1 increases, a burden is imposed on the first MG 71 by as much. As described above, the control device 100 performs a process of ascertaining the state of the vehicle 500 by monitoring the diagnosis data. For example, in order to ascertain a burden imposed on the first MG 71, it is necessary to ascertain the frequency in which the first MG torque T1 increases. In addition, when transitions of the first MG torque T1 when the first MG torque T1 increases are known, for example, a period of duration of the state in which the first MG torque T1 increases can also be ascertained. In this embodiment, one of events determined in the event map includes starting of the internal combustion engine 70. Accordingly, it is possible to record transitions of the first MG torque T1 due to starting of the internal combustion engine 70. When there is this time-series data, it is possible to ascertain the frequency in which the first MG torque T1 increases and the period of duration of the state in which the first MG torque T1 increases due to cranking of the internal combustion engine 70. Accordingly, it is possible to appropriately ascertain the burden of the first MG 71.

(1-5) As described above in (1-4), in order to ascertain the burden imposed on the second MG 72, it is preferable to ascertain the frequency in which the second MG torque T2 increases and the period of duration of the state in which the second MG torque T2 increases. In this embodiment, one of the events determined in the event map includes the brake device 80 performing a sudden braking operation. Accordingly, transitions of the second MG torque T2 due to the brake device 80 performing the sudden braking operation can be recorded. When there is this time-series data, it is possible to ascertain the frequency in which the second MG torque T2 increases and the period of duration of the state in which the second MG torque T2 increases due to the brake device 80 performing the sudden braking operation. Accordingly, it is possible to appropriately ascertain the burden of the second MG 72.

(1-6) The same as described above in (1-5) is true of the third event. That is, in this embodiment, one of the events determined in the event map includes details corresponding to traveling of the vehicle 500 on an undulating road. Accordingly, transitions of the second MG torque T2 due to traveling of the vehicle 500 on the undulating road can be recorded. When there is this time-series data, it is possible to ascertain the frequency in which the second MG torque T2 increases and the period of duration of the state in which the second MG torque T2 increases due to traveling of the vehicle 500 on the undulating road. Accordingly, similarly to (1-5), it is possible to appropriately ascertain the burden of the second MG 72.

### Second Embodiment

A data recording device according to a second embodiment will be described below. The second embodiment is different from the first embodiment only in details of the event map and details of the event processing. In the following description, differences from the first embodiment will be mainly described and description common to the first embodiment will be simplified or omitted.

In the event processing according to this embodiment, the data extracting unit 204 records virtual data which is substituted for target event data as target event data in the data storage unit 206 instead of actually detected target event data. In order to realize this aspect, the event map has the following details.

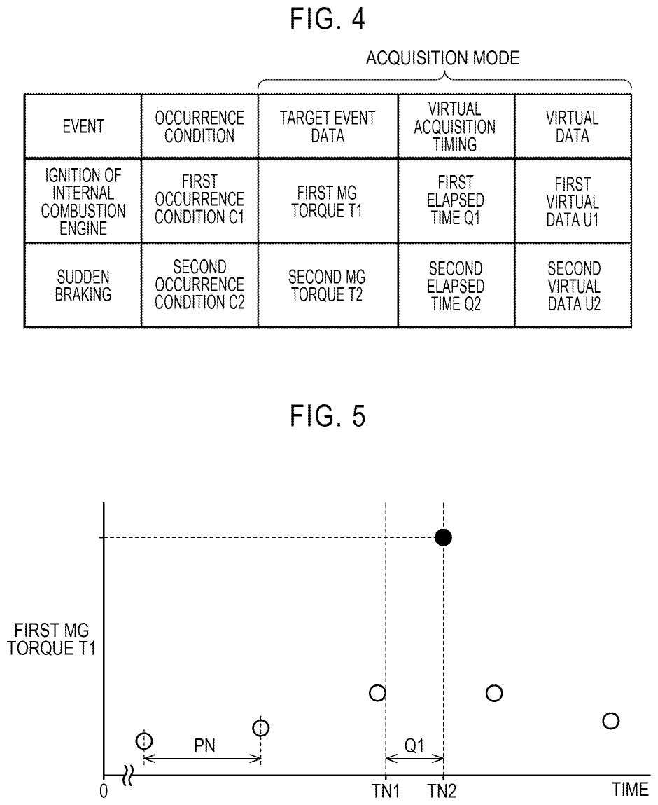

As illustrated in FIG. 4, in the event map, two events, occurrence conditions for each of the two event, and one acquisition mode for each of the two events are determined. In the acquisition mode, target event data, virtual data, and a virtual acquisition timing are determined. The virtual data is virtual data which is considered as target event data and which is applied to a time series of the data storage unit 206. The virtual acquisition timing corresponds an acquisition timing of data and is a timing at which target event data is considered to be detected. The virtual acquisition timing is a time elapsed after occurrence conditions of an event have been satisfied.

A first event which is one of the two events determined in the event map is an event in which the internal combustion engine 70 is started as in the first embodiment. The occurrence conditions and the target event data of the first event are the same as in the first embodiment and thus description thereof will be omitted. In the following description, a value which is set as a target torque of the first MG 71 by the travel control unit 101 when the internal combustion engine 70 is cranked with the first MG 71 is referred to as a target cranking torque. The travel control unit 101 sets the target torque of the first MG 71 as the target cranking torque during a predetermined period after starting conditions of the internal combustion engine 70 have been satisfied. First virtual data U1 which is the virtual data of the first event is the target cranking torque. A slight time is required until the first MG torque T1 actually reaches the target cranking torque after the starting conditions of the internal combustion engine 70 have been satisfied. A first elapsed time Q1 which is the virtual acquisition timing of the first event is set to a value which can be considered to be normal as a time required until the first MG torque T1 actually reaches the target cranking torque after the starting conditions of the internal combustion engine 70 have been satisfied. The first elapsed time Q1 is determined, for example, by experiment. The value which can be considered to be normal can be set to, for example, an average value of values which are acquired when the time required until the first MG torque T1 actually reaches the target cranking torque after the starting conditions of the internal combustion engine 70 have been satisfied is measured under various conditions based on the traveling state of the vehicle 500.

A second event which is one of the two events determined in the event map is an event in which the brake device 80 performs a sudden braking operation as in the first embodiment. Occurrence conditions and target event data of the second event are the same as in the first embodiment and thus description thereof will be omitted. As described above, when the brake device 80 performs a sudden braking operation while the vehicle 500 is traveling, the second MG torque T2 increases suddenly and then decreases suddenly. A maximum value of the second MG torque T2 at this time is referred to as a braking peak value. Second virtual data U2 which is the virtual data of the second event is set to a value which can be considered to be normal as the braking peak value. The second virtual data U2 is determined, for example, by experiment. A second elapsed time Q2 which is the virtual acquisition timing of the second event is set to a value which can be considered to be normal as a time which is required until the second MG torque T2 reaches the braking peak value after the sudden braking conditions for the brake device 80 have been satisfied. The second elapsed time Q2 is determined, for example, by experiment. In both of the braking peak value and the second elapsed time Q2, the values which can be considered to be normal can be determined with the same idea as the first elapsed time Q1.

The details of the event map are the same as described above. The data extracting unit 204 performs an event process on an event of which occurrence conditions have been satisfied based on the details of the event map. When the occurrence conditions of one of the two event are satisfied, the data extracting unit 204 reads the target event data, the virtual acquisition timing, and the virtual data for the event of which the occurrence conditions have been satisfied from the event map. Then, the data extracting unit 204 starts the event process.

When the event process is started, the data extracting unit 204 waits until the virtual acquisition timing arrives. When the virtual acquisition timing arrives, the data extracting unit 204 acquires virtual data stored as an acquisition mode in the data storage unit 206 as the target event data instead of the actually detected target event data. Then, the data extracting unit 204 writes the virtual data to the data storage unit 206. The data extracting unit 204 ends the event process when the virtual data has been written to the data storage unit 206.

### Operation of Second Embodiment

A data acquisition flow will be described below using the first event as an example.

It is assumed herein that the data extracting unit 204 performs acquisition of a first MG torque T1 and writing of the acquired first MG torque T1 to the data storage unit 206 in the normal acquisition cycle PN. As illustrated in FIG. 5, it is assumed that the first occurrence condition C1 is satisfied at a time TN1 while the data extracting unit 204 is repeatedly acquiring the first MG torque T1 in the normal acquisition cycle PN. Then, the data extracting unit 204 starts an event process. That is, the data extracting unit 204 writes the first virtual data U1 to the data storage unit 206 at a time TN2 at which the first elapsed time Q1 has elapsed after the first occurrence condition C1 has been satisfied.

Similarly to the first event, when the second occurrence condition C2 has been satisfied, the data extracting unit 204 writes the second virtual data U2 to the data storage unit 206 at a timing at which the second elapsed time Q2 has elapsed after the second occurrence condition C2 has been satisfied.

Advantages of Second Embodiment

(2-1) In order to ascertain a burden imposed on the first MG 71, it is necessary to ascertain the frequency in which the first MG torque T1 increases as described above in (1-4). According to an aspect of this embodiment, transitions of the first MG torque T1 due to starting of the internal combustion engine 70 cannot be recorded, but the increase of the first MG torque T1 can be left as a record. When there is this record, it is possible to ascertain the frequency in which the first MG torque T1 increases, which is suitable to ascertain the burden imposed on the first MG 71. In this embodiment, since the first MG torque T1 is not actually acquired, the process of acquiring data does not impose a burden on the control device 100. The same is true of the second event.

### Modified Examples

The first embodiment and the second embodiment may be modified as follow. The first embodiment, the second embodiment, and the following modified examples can be combined with each other unless technical confliction arises.

Details of the events determined in the event map are not limited to the examples in the first embodiment and the second embodiment. Any event may be determined in the event map as long as it is an event of which a dedicated acquisition mode needs to be determined. An appropriate acquisition mode can be determined for each event based on details of the event determined in the event map.

The number of events which are determined in the event map is not limited to the examples in the first embodiment and the second embodiment. The number of events determined in the event map has only to be two or more.

In the first embodiment, the event acquisition cycles of a plurality of events are different from each other. However, the event acquisition cycles of the plurality of events may be the same depending on the details of the events determined in the event map. That is, the event acquisition cycles of all the events may be the same or the event acquisition cycles of only some events of the plurality of events may be the same.

As in the aforementioned modified example, the event acquisition periods of a plurality of events may be the same depending on the details of the events determined in the event map.

In the first embodiment, both the event acquisition cycle and the event acquisition period are determined as the acquisition mode. However, the event acquisition cycle may not be determined and only the event acquisition period may be determined. Data may be acquired at irregular timings in the event acquisition period. Data may be acquired in the same acquisition cycle for all the events. In this way, when data is acquired in the same acquisition cycle for all the events, it is not necessary to determine the acquisition cycle for each acquisition mode.

Contrary to the aforementioned modified example, the event acquisition period may not be determined and only the event acquisition cycle may be determined. For an event of which the occurrence conditions have been satisfied, data may continue to be acquired in the event acquisition cycle until the ignition switch is turned off. Data may be acquired in the same acquisition period for all the events. In this way, when data is acquired in the same acquisition period for all the events, it is not necessary to determine the acquisition period for each acquisition mode.

In the second embodiment, only one set of virtual data and a virtual acquisition timing corresponding thereto is determined for one acquisition mode. However, a plurality of sets of virtual data and a virtual acquisition timing corresponding thereto may be determined for one acquisition mode. At this time, the same virtual data may be determined at the virtual timings, or different virtual data may be determined at the virtual timings.

In the second embodiment, virtual data is applied in a time series when the virtual acquisition timing arrives. That is, when the virtual acquisition timing arrives, the virtual data is written to the data storage unit 206. Instead, the virtual data may be applied to a part corresponding to the virtual acquisition timing in the time series in advance, that is, the virtual data may be written to the data storage unit 206 in advance, and actually detected data may be additionally written to before and after the virtually acquired data in the time series later.

The acquisition modes may be determined by combining the acquisition modes of the first embodiment with the acquisition modes of the second embodiment. That is, in one acquisition mode, the event acquisition cycle may be determined and virtual data and a virtual timing corresponding thereto may be determined in addition. When occurrence conditions of an event have been satisfied, the virtual data may be applied as one piece of time-series data when the virtual acquisition timing arrives while acquiring data in the event acquisition cycle.

The types of data recorded on the data storage unit 206 and usage of the recorded data are not limited to the examples of the aforementioned embodiments. Data which is necessary according to usage can be recorded on the data storage unit 206.

It is not essential to determine capacities of the pieces of data which are writable to the data storage unit 206. For example, when an occupant is notified that data is accumulated to a certain extent and is allowed to erase the data, it is not necessary to determine the capacities of the pieces of data.

The storage device may be constituted by a nonvolatile memory.

The mode storage unit 202 may be constituted by the storage device.

The configuration of the vehicle 500 is not limited to that described in the first embodiment. The vehicle may not be a hybrid vehicle. The vehicle may include, for example, only the internal combustion engine 70 as a drive source.

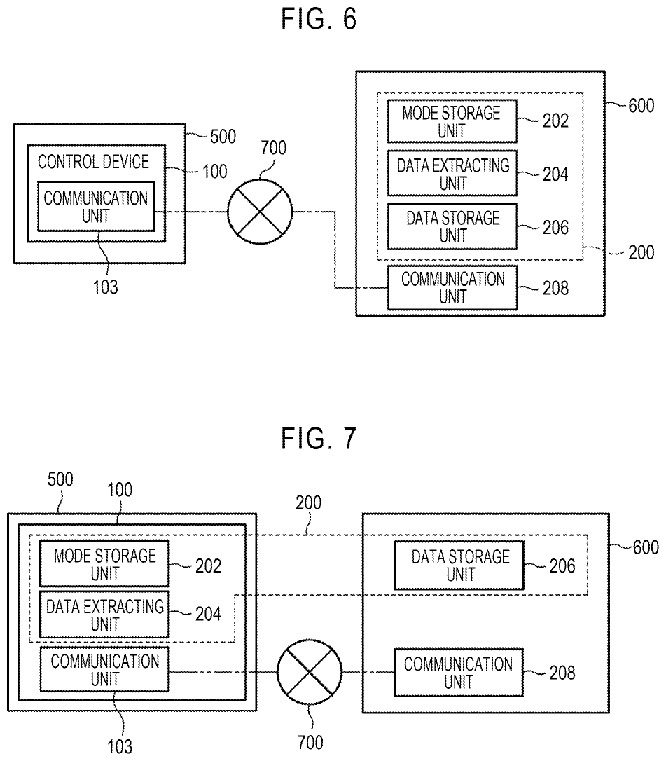

The data recording device 200 may not be constituted by the control device 100 for the vehicle 500. For example, as illustrated in FIG. 6, a server 600 may be provided outside the vehicle 500 and the data recording device 200 may be constituted by the server 600. That is, the server 600 may have a configuration including the data extracting unit 204, the mode storage unit 202, and the data storage unit 206. In this case, the server 600 may include one or more processors that perform various processes in accordance with a computer program (software). The server 600 may be configured as one or more dedicated hardware circuits such as an application-specific integrated circuit (ASIC) that performs at least some of the processes or circuitry including a combination thereof. The processor includes a CPU and a memory such as a RAM and a ROM. The memory stores program codes or commands for causing the CPU to perform the processes. The memory, that is, a computer-readable medium includes all available mediums that can be accessed by a general-purpose or dedicated computer. The server 600 also includes a storage device which is an electrically rewritable nonvolatile memory. The server 600 includes a communication unit 208 that communicates with the outside of the server 600 via an external communication circuit network 700.

When the data recording device 200 is constituted by the server 600, a communication unit 103 that communicates with the outside of the control device 100 via the external communication circuit network 700 may be provided in the control device 100 for the vehicle 500. The control device 100 for the vehicle 500 can transmit data of various types of sensors to the server 600. With this configuration, the server 600 can record data on the data storage unit 206 similarly to the case in which the data recording device is constituted by the control device 100 for the vehicle 500.

In the modified example illustrated in FIG. 6, the vehicle 500 may transmit data to the server 600 whenever the data is detected by the sensors, or may transmit data to the server 600 every predetermined period, every predetermined number of pieces of data, or every predetermined data capacity.

As illustrated in FIG. 7, the data extracting unit 204, the mode storage unit 202, and the data storage unit 206 may be distributed to the control device 100 for the vehicle 500 and the server 600. That is, the data recording device 200 may be constituted by both the control device 100 for the vehicle 500 and the server 600. In this case, for example, the data extracting unit 204 and the mode storage unit 202 can be provided in the control device 100 for the vehicle 500 and the data storage unit 206 can be provided in the server 600. As in the example illustrated in FIG. 6, a communication unit 103 may be provided in the control device 100 for the vehicle 500 and a communication unit 208 may be provided in the server 600. With this configuration, data acquired by the data extracting unit 204 of the control device 100 for the vehicle 500 can be transmitted to the server 600 and the server 600 can receive the data and record the received data on the data storage unit 206.

In the modified examples illustrated in FIGS. 6 and 7, the communication unit may be provided as a part of the data recording device 200.

In the second embodiment, virtual data may be acquired afterward instead of acquiring the virtual data at the virtual acquisition timing. For example, when data and an acquisition timing of the data are correlated for each event having occurred and stored as a table in the data storage unit 206, virtual data and a virtual acquisition timing may be added as data and an acquisition timing to the table of the corresponding event. In this way, an embodiment in which virtual data and a virtual acquisition timing are additionally written does not cause any particular problem as long as data is used to analyze the state of the vehicle 500 associated with an event having occurred afterward.

What is claimed is:

1. A data recording device that records data on a vehicle when an operation state of the vehicle satisfies occurrence conditions of an event, the data recording device comprising:
a mode storage unit configured to store a plurality of acquisition modes in which at least one of an acquisition timing of the data and an acquisition period of the data is determined;
a data extracting unit configured to extract some data out of the detected data; and
a data storage unit configured to store the data extracted by the data extracting unit,
wherein the mode storage unit is configured to store occurrence conditions of a plurality of events and to store one acquisition mode in correlation with each of the plurality of events, and
wherein the data extracting unit is configured to extract the data in accordance with rules of the acquisition mode corresponding to the event of which the occurrence conditions are satisfied.

2. The data recording device according to claim 1, wherein an acquisition cycle of the data is determined as the acquisition timing of the data for each acquisition mode.

3. The data recording device according to claim 1, wherein a period until acquisition of the data ends after the occurrence conditions have been satisfied is determined as the acquisition period of the data for each acquisition mode.

4. The data recording device according to claim 1, wherein virtual data and a virtual acquisition timing at which the virtual data is considered to have been detected are determined for each acquisition mode, and
wherein the data extracting unit is configured to extract the virtual data which is determined for the acquisition mode corresponding to the event of which the occurrence conditions have been satisfied as the data detected at the virtual acquisition timing.

5. The data recording device according to claim 1, wherein, when one of the plurality of events is a first event, the first event is an event in which an internal combustion engine starts its ignition, and
wherein, when the acquisition mode correlated with the first event is a first acquisition mode, a torque of a starting motor that performs cranking of the internal combustion engine is determined as a type of the acquired data for the first acquisition mode.

6. The data recording device according to claim 1, wherein, when one of the plurality of events is a second event, the second event is an event in which a brake device of the vehicle operates, and
wherein, when the acquisition mode correlated with the second event is a second acquisition mode, a torque of a traveling motor that is able to transmit power to driving wheels of the vehicle is determined as a type of the acquired data for the second acquisition mode.

7. The data recording device according to claim 1, wherein, when one of the plurality of events is a third event, the third event is an event in which a state in which a change per unit time of an acceleration in a vertical direction of the vehicle is equal to or greater than a prescribed value is maintained for a prescribed period or longer, and
wherein, when the acquisition mode correlated with the third event is a third acquisition mode, a torque of a traveling motor that is able to transmit power to driving wheels of the vehicle is determined as a type of the acquired data for the third acquisition mode.
